(19) United States
(12) Patent Application Publication
(10) Pub. No.: US 2007/0147311 A1
(43) Pub. Date: Jun. 28, 2007

(54) Automatically activating wireless fidelity capability for a mobile station

(76) Inventor: Jacco Brok, Overijssel (NL)

Correspondence Address: CARLSON, GASKEY & OLDS, P.C., 400 W MAPLE RD, SUITE 350, BIRMINGHAM, MI, 48009, US

(21) Appl. No.: 11/320,521

(22) Filed: Dec. 28, 2005

(51) Int. Cl. H04B 7/216; H04Q 7/00

(52) U.S. Cl. 370/335; 370/332

(57) ABSTRACT

A mobile station (20) includes a first portion (24) having wireless fidelity communication capability. A second portion (28) of the mobile station (20) determines when at least one source (26) of wireless fidelity communications is within an acceptable range of the mobile station (20) to facilitate wireless fidelity communications. The second portion (28) provides an indication for automatically activating the first portion (24) whenever the mobile station (20) is appropriately situated for Wi-Fi communications.

### FIELD OF THE INVENTION

This invention generally relates to communications. More particularly, this invention relates to wireless communications.

### DESCRIPTION OF THE RELATED ART

Wireless communication systems are well known and in widespread use. Cellular communication networks typically include a plurality of base stations geographically located to serve corresponding regions or cells. Mobile stations such as cell phones, personal digital assistants and laptop computers communicate using radio frequency signals through the base stations to a cellular network, which facilitates communications with other devices.

There are other wireless communication technologies that are available such as IEEE 802.11 wireless fidelity (Wi-Fi) communications. Wi-Fi communications typically have higher bandwidth capability than IP connectivity available through cellular networks. Additionally, Wi-Fi communications are typically available at a lower cost. Wi-Fi communication capability, however, is typically limited to within a closer range of a Wi-Fi access point or source of Wi-Fi communications. Typical ranges are from about fifty to several hundred meters. Wi-Fi access points can be located inside of buildings that are privately owned or in public buildings, for example.

Some mobile stations have the capability of communicating using a cellular network, Wi-Fi communications or both. Some known mobile stations have a connection manager that switches between Wi-Fi and cellular-based (e.g., WAN IP connectivity) communications based on the availability of each network and other criteria such as application needs, etc. With such devices, the connection manager software relies upon the Wi-Fi network card of the mobile station to provide an indication whether a Wi-Fi communication network is currently available. Leaving a Wi-Fi network card switched on for this purpose undesirably utilizes battery power because the network card must be switched on even while it is not being used.

In some cases, the user of the mobile station can manually select which technology to access. For example, an individual having such a device may switch on the Wi-Fi capability of the device once the individual arrives at the office where there is a Wi-Fi access point. There is a disadvantage associated with manual activation in that it can be inconvenient for the user. Additionally, the user may inadvertently leave on a Wi-Fi network card, which has the battery draining disadvantage mentioned above.

It would be advantageous to provide automatic management of Wi-Fi capability for a mobile station that does not rely upon the Wi-Fi capability of the mobile station for activation. This invention addresses that need.

### SUMMARY OF THE INVENTION

An exemplary method of communicating includes automatically controlling activation of wireless fidelity capability of a mobile station responsive to an indication of wireless fidelity communication availability based upon at least one second, different capability of the mobile station.

One example includes activating the wireless fidelity capability when the indication corresponds to available wireless fidelity communications and deactivating the wireless fidelity capability when the indication is that the wireless fidelity communications are not available.

In one example, the indication corresponds to a proximity of the mobile station relative to at least one source of wireless fidelity communications.

In one example, the second, different capability of the mobile station allows for determining a location of the mobile station. A determination whether that location is within a communication range of a location of at least one source of wireless fidelity communications allows for responsively and automatically activating the wireless fidelity capability of the mobile station. In one example, the responsive, automated activation includes turning on a wireless fidelity network card.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 schematically shows selected portions of a communication arrangement including a mobile station that has wireless fidelity communication capability.

FIG. 2 is a flowchart diagram summarizing one example approach that is useful in an embodiment of this invention.

### DETAILED DESCRIPTION

This invention allows for automatically controlling the activation of wireless fidelity (Wi-Fi) communication capability for a mobile station without relying upon the Wi-Fi capability of the mobile station for such activation. With the disclosed example, it is possible to automatically control the activation of the Wi-Fi capability for a mobile station by utilizing at least one other communication or detection capability of the mobile station for determining when Wi-Fi communications are available.

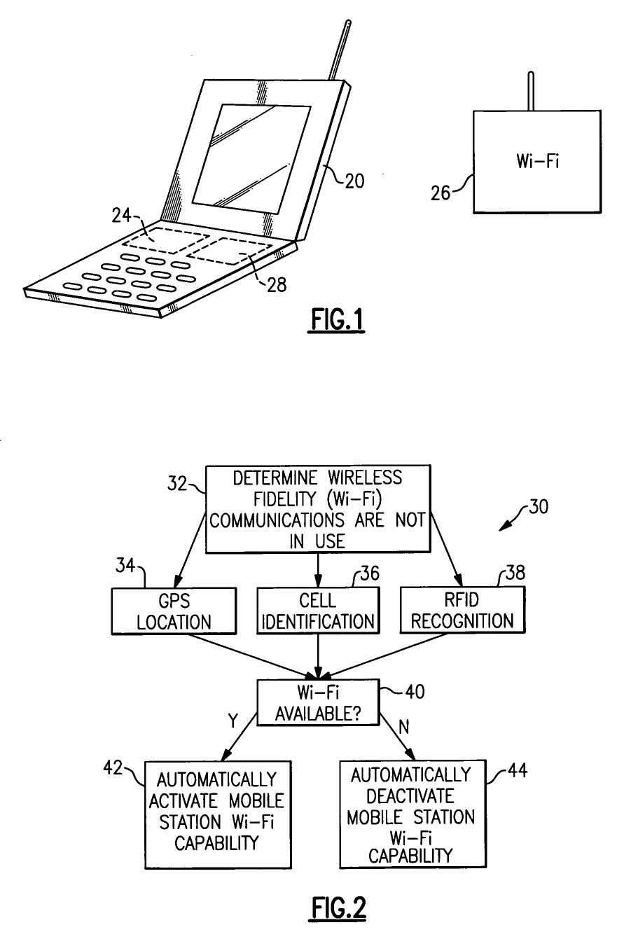

FIG. 1 schematically shows an example mobile station 20. While the illustration shows a cellular phone, other mobile stations can be used in an embodiment of this invention. Example mobile stations include personal digital assistants and notebook or laptop computers. This invention is not necessarily limited to any particular type of mobile station.

The example mobile station 20 includes a first portion 24 that provides the mobile station 20 with Wi-Fi capability. In one example, the first portion 24 of the mobile station 20 comprises a Wi-Fi network card. In the illustration, the mobile station 20 can communicate with at least one source 26 of Wi-Fi communications. The source 26 may be any known Wi-Fi access point or device.

The example mobile station 20 includes a second portion 28 that facilitates at least one second, different type of communication or detection capability for the mobile station 20. The second portion 28 in this example determines when the mobile station 20 is located or situated to allow for Wi-Fi communications with the source 26, for example. Depending on the technology capabilities of the second portion 28, different information may be used for making such a determination.

FIG. 2 includes a flowchart diagram 30 that summarizes one example approach. The flowchart 30 begins at 32 with a determination that Wi-Fi communications are not currently in use. If the mobile station 20 is currently being used for Wi-Fi communications, then the first portion 24 is active according to a user's preference. No automatic control of activation is necessary in most cases under such circumstances. When Wi-Fi communications are not currently in use, the second portion 28 uses technology other than the technology available from the first portion 24 for making a determination that is useful for automatically controlling the activation of the Wi-Fi capability. In the example of FIG. 2, three options for making such a determination are shown for discussion purposes. Some mobile stations will have other capabilities available in addition to or in place of the options included in the illustrated example.

At 34, a global positioning system (GPS) location technique provides an indication of a current location of the mobile station 20. In this example, the second portion 28 includes a GPS receiver that works in a known manner to make a determination regarding a location of the mobile station 20. The GPS receiver may be independent and communicate with a GPS system on its own or it may be an assisted GPS receiver as known.

Once a geographic location of the mobile station 20 is determined, the mobile station 20 can make a determination whether any Wi-Fi access points or sources 26 are within a sufficient range of that location to facilitate Wi-Fi communications on behalf of the mobile station 20. One example includes a look up table of known Wi-Fi source locations. Another example includes stored data regarding previous location at which the mobile station 20 has conducted Wi-Fi communications. The appropriate range will depend upon at least one characteristic of the source of Wi-Fi communications such as the range of that source, assuming that the range is known or can be determined.

In the example of FIG. 2, a cell identification technique at 36 allows for determining a geographic location of the mobile station 20. In this example, the second portion 28 comprises a cell identifier module that may comprise hardware, software or a combination of them for identifying a current cell within which the mobile station 20 is located. Cellular networks are typically divided into cells that have a range from 500 meters to 10 kilometers. In many suburban areas, cells range between 500 and 1500 meters.

The example mobile station 20 utilizes circuit switched call support (e.g., GSM, CDMA) to detect the current cell within which the mobile station is located. In this example, the cell has an identification unique to that cell. The mobile station 20 in one example can determine whether Wi-Fi communication is available within that cell based upon information regarding at least one source of Wi-Fi communication within that cell. Such information may include know Wi-Fi source locations stored in a look up table or otherwise available from the network with which the mobile station is communicating, for example. In another example, the mobile station 20 includes or has access to memory for storing a plurality of cell identifications corresponding to locations where the mobile station has previously conducted Wi-Fi communications.

The example of FIG. 2 includes another technique for determining whether Wi-Fi communications may be available using technology other than Wi-Fi capability for making the determination. In this example, the second portion 28 includes a radio frequency identifier recognition module that works in a known manner. At 38, a radio frequency identifier (RFID) capability allows the mobile station 20 (more particularly, the second portion 28) to detect an RFID tag. Based upon information regarding the RFID tag, the mobile station 20 can determine whether it is in an acceptable range of a source 26 of Wi-Fi communications. That determination can be based upon, for example, data (such as a look up table) regarding appropriate Wi-Fi tags and known Wi-Fi source locations or data including an indication of RFID tags corresponding to locations where the mobile station 20 has previously conducted Wi-Fi communications.

The example techniques shown at 34, 36 and 38 in FIG. 2 may be used individually or in combination (e.g., two or all three) for making a determination whether the mobile station 20 is in a position or situated for potential Wi-Fi communications with a source 26 of Wi-Fi communications. This determination is made at 40 in FIG. 2.

Other capabilities of mobile stations may be used instead of or in combination with one or more of the example techniques shown at 34, 36 and 38 in FIG. 2. Example alternative capabilities include a camera capability, a video capability, a microphone capability, a temperature detection capability and a recognition that the mobile station is positioned or received within a cradle. Given this description, those skilled in the art will be able to select from among such capabilities to make a determination regarding Wi-Fi availability to meet the needs of their particular situation.

Assuming that the first portion 24 of the mobile station 20 is not activated, the process in FIG. 2 continues at 42 when Wi-Fi communications are available by automatically activating the mobile station Wi-Fi capability. In one example, this includes turning on a Wi-Fi network access card that is part of the first portion 24 of the mobile station 20.

Assuming that the first portion 24 is activated and the determination at 40 is negative (e.g., the mobile station 20 is not in a location corresponding to available Wi-Fi access), the example of FIG. 2 includes a step at 44 for automatically deactivating the mobile station Wi-Fi capability. In one example, this includes automatically switching off a Wi-Fi network access card that is part of the first portion 24. One example includes confirming that Wi-Fi access is not available, using the first portion 24 for example, before implementing automatic deactivation.

The disclosed example includes the significant advantage of automatically activating or disabling Wi-Fi capability on a mobile station without requiring a Wi-Fi network card to be activated to make a determination whether Wi-Fi communications are available. This presents significant battery power savings in many instances.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A method of communicating, comprising:
automatically controlling activation of a wireless fidelity capability of a mobile station responsive to an indication based upon at least one second, different capability of the mobile station regarding wireless fidelity communication availability.

2. The method of claim 1, comprising
automatically activating the wireless fidelity capability if the indication is that wireless fidelity communications are available.

3. The method of claim 1, comprising
automatically deactivating the wireless fidelity capability if the indication is that wireless fidelity communications are not available.

4. The method of claim 1, wherein the indication is based upon a proximity of the mobile station relative to at least one source of wireless fidelity communications.

5. The method of claim 4, comprising
determining a location of the mobile station using the at least one second, different capability of the mobile station; and
determining whether the determined location is within a communication range of the at least one source of wireless fidelity communications.

6. The method of claim 4, wherein the second, different capability comprises at least one of:
a global positioning system location capability, a camera capability, a temperature measurement capability, a cradle detection capability, a microphone capability, a radio frequency identifier recognition capability, or a cellular network cell identifier capability.

7. The method of claim 4, comprising
determining a geographic location of the mobile station;
determining whether the at least one source of wireless fidelity communications is within a selected range of the determined geographic location of the mobile station; and
providing the indication when the at least one source is within the selected range of the mobile station.

8. The method of claim 7, comprising
selecting the range based upon at least one characteristic of the at least one source.

9. The method of claim 4, comprising
determining a current cellular network cell within which the mobile station is located;
determining whether the at least one source of wireless fidelity communications is within the current cell; and
providing the indication when the current cell includes the at least one source of wireless fidelity communications.

10. The method of claim 4, comprising
detecting at least one radio frequency identifier tag;
determining whether the detected tag corresponds to a location within a selected range of the at least one source of wireless fidelity communications; and
providing the indication when the detected tag corresponds to the mobile station being within the selected range of the at least one source.

11. A mobile station, comprising
a first portion having a wireless fidelity communications capability; and
a second portion having at least one other, different capability, the second portion providing an indication regarding an availability of wireless fidelity communications determined by the second portion, the mobile station automatically controlling activation of the wireless fidelity communications capability responsive to the indication.

12. The mobile station of claim 11, wherein the mobile station automatically activates the wireless fidelity capability if the indication is that wireless fidelity communications are available.

13. The mobile station of claim 11, wherein the mobile station automatically deactivates the wireless fidelity capability if the indication is that wireless fidelity communications are not available.

14. The mobile station of claim 11, wherein the indication is based upon a proximity of the mobile station relative to at least one source of wireless fidelity communications.

15. The mobile station of claim 11, wherein the second portion
determines a location of the mobile station using the at least one other, different communication capability of the mobile station; and
determines whether the determined location is within a communication range of a location of the at least one source of wireless fidelity communications.

16. The mobile station of claim 15, wherein the second portion comprises at least one of:
a global positioning system receiver;
a radio frequency identifier recognition module; or
a cell identifier module.

17. The mobile station of claim 11, wherein the second portion
determines a geographic location of the mobile station;
determines whether at least one source of wireless fidelity communications is within a selected range of the determined geographic location of the mobile station; and
provides the indication when the at least one source is within the selected range of the mobile station.

18. The mobile station of claim 11, wherein the second portion
selects the range based upon at least one characteristic of the at least one source.

19. The mobile station of claim 11, wherein the second portion
determines a current cellular network cell within which the mobile station is located;
determines whether at least one source of wireless fidelity communications is within the current cell; and
provides the indication when the current cell includes the at least one source of wireless fidelity communications.

20. The mobile station of claim 11, wherein the second portion
detects at least one radio frequency identifier tag;
determines whether the detected tag corresponds to a location within a selected range of at least one source of wireless fidelity communications; and
provides the indication when the detected tag corresponds to the mobile station being within the selected range of the at least one source.
